(19) United States
(12) Patent Application Publication
(10) Pub. No.: US 2006/0162093 A1
(43) Pub. Date: Jul. 27, 2006

(54) Treating textile materials with polyorganosiloxanes

(76) Inventors: Josette Chardon, Lyon (FR); Philippe Olier, Lyon (FR)

Correspondence Address: Jean-Louis Seugnet;INTELLECTUAL PROPERTY DEPT., RHODIA INC., 259 Prospect Plains Road, CN 7500, Cranbury, NJ, 08512-7500, US

(21) Appl. No.: 11/391,531

(22) Filed: Mar. 28, 2006

Related U.S. Application Data
(63) Continuation of application No. 10/381,912, filed on Mar. 28, 2003.

(30) Foreign Application Priority Data
Oct. 5, 2000 (FR) 00/12739

(51) Int. Cl. C11D 3/00

(52) U.S. Cl. 8/115.51

(57) ABSTRACT

The invention concerns a method for treating textile materials providing said textile materials with a soft feel, absence of yellowing and good hydrophily, which consists in contacting the textile materials with a composition comprising at least a linear, cyclic or three-dimensional polyorganosiloxane of formula (I), wherein: the symbols Z, identical or different, represent R1, and/or V; and the symbols V represent a group of stericallyhindered piperidinyl function(s).

The present invention relates to a method for treating textile materials providing the textile fiber with good hydrophilicity, absence of yellowing and a soft feel to the touch, that is to say properties of softness.

Various approaches are described in the prior art for obtaining textile softening treatments.

The document U.S. Pat. No. 4,409,267 describes, for example, the use of a mixed polyorganosiloxane carrying, on the one hand, a primary or secondary amine functional group or groups substituted, for example, with residues containing an OH or O-alkyl group, and, on the other hand, a polyalkylene oxide functional group or groups as additive for a composition for treating textile materials. The document EP 546 231 describes another approach via the use of a polyorganosiloxane carrying a unit or units of formula Si—(CH₂)_{y}—(OCH₂)_{y′}—CH(OH)CH₂—N(CH₂CH₂OH)₂ where y is between 2 and 8 and y′ is equal to 0 or 1.

The applicant has also proposed solutions described in particular in EP 659 930 and FR 2,745,825.

EP 659 930 describes silicone-based textile softeners comprising from 2 to 1 600 silicon atoms, carrying one to one hundred sterically hindered amino units and optionally other units such as, for example, alkyl radicals having from 5 to 20 carbon atoms or radicals —(CH₂)ₚ—COOR—R.

FR 2,745,825 describes silicone-based textile softeners carrying at least one sterically hindered amino unit and at least one polyether type radical of formula (CH₂)ₙ—(OCH₂CH₂)_{α}(OCH₂CHCH₃)_{β}—OR.

These approaches have led to the preparation of silicones in which the softening properties are provided to the textile in particular by the presence of amino functional groups, and the hydrophilic properties are provided in particular by the presence of polar functional groups such as polyether-type functional groups, the latter partially compensating for the loss of hydrophilicity of the material treated with silicone. It should be noted, in addition, that the preparation of these products uses routes of syntheses which are relatively complex and which are therefore scarcely economically viable.

Now, the applicant has found, unexpectedly, that silicone compounds have remarkable advantages compared with the other compounds known in the prior art.

Indeed, the applicant has developed a novel method for treating textile using softening, hydrophilic and nonyellowing silicone oils carrying sterically hindered amino functional groups. This innovative approach consists in providing the textile material with the softness and the absence of yellowing by treatment with a silicone oil carrying a hindered amino functional group, without masking the intrinsic hydrophilicity of the textile material treated.

Another advantage of the method of treating textile according to the present invention comes from the fact that it can be carried out with a polyorganosiloxane which is easy to prepare industrially and which is stable during storage.

Another advantage of the method for treating textile according to the present invention comes from the easy treatment of the composition containing the polyorganosiloxane according to the invention for its application to the materials to be treated.

There has therefore now been found, and that is what constitutes the subject of the present invention, a method for treating textile materials in order to provide them with a soft feel, absence of yellowing and good hydrophilicity, in which the textile materials are brought into contact with a composition comprising at least one linear, cyclic or three-dimensional polyorganosiloxane of formula (I): 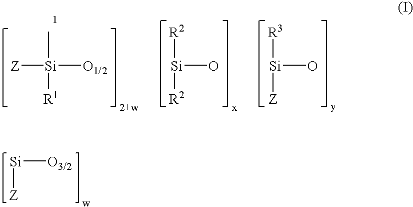
in which:
(1) the symbols Z, which are identical or different, represent R¹, and/or V;
(2) the symbols R¹, R² and R³, which are identical or different, represent a monovalent hydrocarbon radical chosen from linear or branched alkyl radicals having from 1 to 4 carbon atoms, linear or branched alkoxy radicals having from 1 to 4 carbon atoms, a phenyl radical and, preferably, a hydroxyl radical, an ethoxy radical, a methoxy radical or a methyl radical;
(3) the symbols V, functional groups which are identical or different, represent a group containing a sterically hindered piperidinyl functional group or groups chosen from:

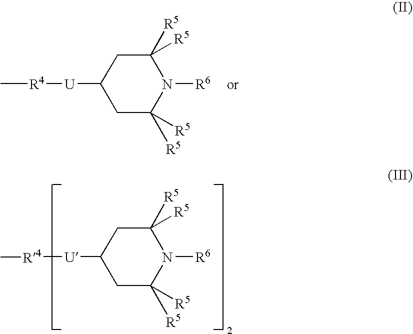

For the groups of formula (II):

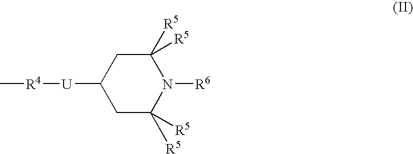

R⁴ is a divalent hydrocarbon radical chosen from:
linear or branched alkylene radicals having 2 to 18 carbon atoms;
alkylene-carbonyl radicals in which the linear or branched alkylene portion contains 2 to 20 carbon atoms;
alkylene-cyclohexylene radicals in which the linear or branched alkylene portion contains 2 to 12 carbon atoms and the cyclohexylene portion contains an OH group and optionally 1 or 2 alkyl radicals having 1 to 4 carbon atoms;
radicals of formula —R⁷—O—R⁷ in which the radicals R⁷, which are identical or different, represent alkylene radicals having 1 to 12 carbon atoms;
radicals of formula —R⁷—O—R⁷ in which the radicals R⁷ have the meanings indicated above and one of them or both of them are substituted by one or two —OH group or groups;
radicals of formula —R⁷—COO—R⁷ in which the radicals R⁷ have the meanings indicated above;
radicals of formula —R⁸—O—R⁹—O—CO—R⁸ in which the radicals R⁸ and R⁹, which are identical or different, represent alkylene radicals having 2 to 12 carbon atoms and the radical R⁹ is optionally substituted by a hydroxyl radical;
U represents —O— or —NR¹⁰—, R¹⁰ being a radical chosen from a hydrogen atom, a linear or branched alkyl radical containing 1 to 6 carbon atoms and a divalent radical of formula: 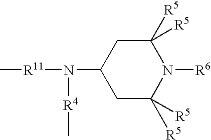
in which R⁴ has the meaning indicated above, R⁵ and R⁶ have the meanings indicated below and R¹¹ represents a linear or branched divalent alkylene radical having from 1 to 12 carbon atoms, one of the valency bonds (that of R¹¹) being linked to the atom of —NR¹⁰—, the other (that of R⁴) being linked to a silicon atom;

the radicals R⁵, which are identical or different, are chosen from linear or branched alkyl radicals having 1 to 3 carbon atoms and the phenyl radical;

the radical R⁶ represents a hydrogen radical or the radical R⁵ or O·.

For the groups of formula (III): 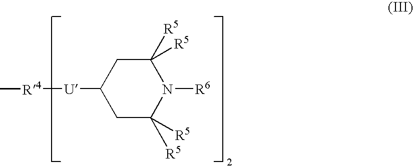
R′⁴ is chosen from a trivalent radical of formula: 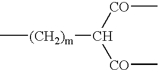
   where m represents a number from 2 to 20, and a trivalent radical of formula: 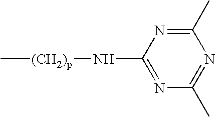
   where p represents a number from 2 to 20;
U′ represents —O— or NR¹²—, with R¹² being a radical chosen from a hydrogen atom, a linear or branched alkyl radical containing 1 to 6 carbon atoms;

R⁵ and R⁶ have the same meanings as those given with respect to the formula (II); and

(4)—the number of units ηSi with no group V is between 10 and 450,
the number of units ηSi with a group V is between 1 and 5
0≦w≦10 and 8<y<448

Advantageously, at least one of the silicone oils selected for the textile treatment is such that the number of units ηSi with no group V is between 50 and 250, and the number of units ηSi with a group V is between 1 and 3.

The silicone oil used in the context of the invention in particular does not require the presence of other functional groups to provide the treated textile material with hydrophilic properties. However, if it is desired to obtain a hydrophilicity greater than that intrinsic to material before treatment, the silicone oil used may contain other functional groups which promote this property.

According to a preferred embodiment of the method of the invention, the polyorganosiloxane of formula (I) used is linear.

According to another preferred embodiment, the functional group V of the polyorganosiloxane of formula (I) used is chosen from the functional groups of formula (II).

Regardless of the constitution chosen for the composition containing the polyorganosiloxane, the method of treatment may be carried out on materials of the woven, nonwoven or knitted form. The fibers of these materials are at least partially hydrophilic, and this hydrophilicity is preserved after treatment with silicone according to the invention regardless of the hydrophobic nature of its backbone.

The materials, which are at least partially hydrophilic, may in particular consist of or be based on cotton, flax, wool, viscose, rayon, hemp, silk or a mixture of these materials. These materials may be optionally mixed with other materials which are scarcely or not hydrophilic, such as polyester (for example a cotton-polyester mixture), keratin, polypropylene, polyethylene, polyurethane, polyamide or cellulose, acetate.

The composition containing the polyorganosiloxane may be prepared in numerous forms: liquid, gaseous or solid. In the case of a liquid preparation of the composition, it will be advantageously aqueous, either in the form of a solution, dispersion or emulsion.

Preferably, the composition is prepared in the form of an aqueous emulsion. However, the composition according to the method of the invention may also be used in solution in an organic solvent.

The aqueous emulsions are generally based on a mixture of oil and water, and are prepared according to conventional methods well known to persons skilled in the art, using surfactants. For example, the emulsions may be prepared by so-called direct methods or by inversion. Their implementation is easy and does not require the use of equipment having a high stirring rate. Equipment with a normal stirring rate may be used.

In general, the aqueous emulsions prepared in accordance with the invention preferably contain between 20 and 90% by weight of water relative to the total mass of the constituents of the emulsion. For a better application, the emulsions prepared in accordance with the invention are preferably diluted so as to contain between 95 and 99.5% by weight of water, relative to the total weight of the emulsion. These emulsions are found to be stable at room temperature.

The application of the polyorganosiloxane according to the invention to the materials to be treated may be carried out in a wide variety of forms. The applications may be carried out by immersion, coating, spraying, impression, padding or by any other existing means.

For example, when the fabric is treated with an aqueous composition containing a polyorganosiloxane according to the invention, said fabric is subjected to a heat treatment in order to rapidly expel the water in vapor form.

The quantity of polyorganosiloxane deposited on the material to be treated varies according to the make-up and the manufacture of said material. Applications of the compositions and in particular of aqueous emulsions to the treated materials are carried out such that the increase in weight of the treated material does not exceed 0.1 to 20% by weight relative to the weight of the material before treatment. In general, the best results were obtained with a quantity of polyorganosiloxane of between 0.1 and 2% by weight relative to the weight of the material to be treated.

The polyorganosiloxanes defined above may be prepared according to various methods, for example: distribution or hydrosilylation.

### EXAMPLES

The examples below illustrate the properties of the silicone oils according to the invention.

The oils are tested by applying in the form of an aqueous emulsion and the measurements of hydrophilicity, nonyellowing and evaluation of feel are carried out according to the tests described below.

Measurement of Nonyellowing (Whiteness Value)

The evaluation of the yellowing is carried out by measuring the color of the cloth (white cotton toweling at the beginning) after impregnation with silicone oil and heat treatment of 9 minutes at 150° C.

The measurement of color is carried out on an ACS Sensor II spectrophotocolorimeter marketed by the company Datacolor. The conditions of measurement are the use of the D65 illuminant, which reproduces daylight. Using the measurement of the color of the cloth sample, the apparatus calculates the values of various whiteness and yellowing values, among which we shall use the CIE whiteness value.

Test of Feel

After applying oil, the cotton toweling is dried in ambient air for 24 hours. After a heat treatment of 1 minute 30 seconds at 150° C., the cloth is placed for 24 hours for conditioning (23±2° C., 50±5% relative humidity).

The softness is evaluated by a group of testers who are asked to classify the roughest cloth samples (minimum score=1) and the softest cloth samples (maximum score=total number of samples).

Measurement of Hydrophilicity

After applying oil, the polyester-cotton cloth (50/50) undergoes a heat treatment of 5 minutes at 170° C., It is then conditioned for 24 hours (23≅2° C., 60±5% relative humidity).

The measurements of hydrophilicity are given by the TEGEWA test in which the time for absorbing a drop of water deposited at the surface of the cloth is measured. The shorter the time, the more hydrophilic the cloth.

Preparation of the Emulsions

The silicone oils of the emulsions tested E1 to E7 have the structure:

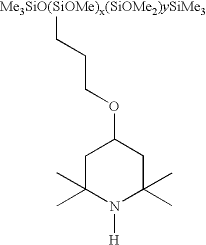

The number of D units and amino units of the oils used is specified in table I.

The emulsions are prepared using a method of emulsification by inversion, and have the following composition: 20 g of silicone oil tested, 8 g of surfactant (C₁₃E₆ fatty alcohol), a quantity of glacial acetic acid which is stoichiometrically necessary for neutralizing the amine and the balance for 100 g with water.

TABLE I

| | | |
|---|---|---|
| Emulsion | y | x |

Examples

| | | |
|---|---|---|
| E1 | 100 | 0.5 |
| E2 | 100 | 1 |
| E3 | 100 | 2 |
| E4 | 100 | 4 |
| E5 | 250 | 2.5 |

Counter-examples

| | | |
|---|---|---|
| E6 | 350 | 9 |
| E7 | 450 | 16.5 |

The evaluations were made on textiles treated with 0.6% by weight of silicone oil. The emulsions are applied to the cloth by padding.

The properties of the cloths treated with the various emulsions E1 to E7 were evaluated and compared with each other per series. The results obtained for each series are not absolute values but relative values which are comparable within the same series.

First series

| Emulsion | Nonyellowing |
|---|---|
| E1 | 52.7 |
| E2 | 53.2 |
| E3 | 52.1 |
| E4 | 53.9 |
| Control | 54.2 |

This series demonstrates the nonyellowing of the cloths treated with an emulsion based on silicone oils according to the invention; indeed, the whiteness value is close to that of an untreated cloth.

Second series

| Emulsion | Feel | Hydrophilicity |
|---|---|---|
| E1 | 3 | 6.5 |
| E2 | 6 | 7 |
| E3 | 10 | 8.5 |
| E5 | 7 | 9.7 |
| E6 | 11 | 15.8 |
| E7 | 12 | 17.9 |

This series demonstrates the hydrophilic and softening properties of the oils according to the invention.

Third series

| Emulsion | Feel | Hydrophilicity |
|---|---|---|
| E1 | 1 | 6.1 |
| E3 | 6 | 7.4 |
| E4 | 4 | 8.5 |
| E7 | 8 | 18.5 |

This series, as the preceding one, demonstrates the hydrophilic and softening properties of the oils according to the invention.

1-9. (canceled)

10. A method for treating textile materials in order to provide them with a soft feel, absence of yellowing and good hydrophilicity, in which the textile materials are brought into contact with a composition comprising at least one linear, polyorganosiloxane of formula: 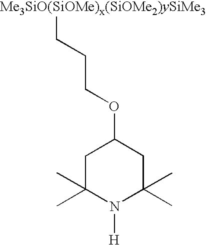
wherein x is a number of between 0.5 and 4, limits included and y is a number comprised between 100 and 250, limits included.

11. The method as claimed in claim 10, wherein the composition containing the polyorganosiloxane is in liquid form.

12. The method as claimed in claim 11, wherein the polyorganosiloxane in liquid form is an aqueous emulsion.

13. The method as claimed in claim 10, wherein said method is carried out on a woven, knitted or nonwoven material, said material being at least intrinsically hydrophilic.

14. The method as claimed in claim 10, wherein the material treated is based on cotton, flax, wool, viscose, rayon, hemp, silk or a mixture of these materials.

15. The method as claimed in claim 10, wherein the polyorganosiloxane is deposited on the treated textile material in a quantity of between 0.1 and 2% by weight relative to the weight of the treated dry textile material.
